(19) United States
(12) Patent Application Publication
(10) Pub. No.: US 2025/0077877 A1
(43) Pub. Date: Mar. 6, 2025

(54) IDENTIFYING TRANSFORMATIONS IN DATA FABRIC USING COUNTERFACTUAL EXPLANATIONS OF ENTITY MATCHING

(71) Applicant: INTERNATIONAL BUSINESS MACHINES CORPORATION, ARMONK, NY (US)

(72) Inventors: Balaji Ganesan, Bengaluru (IN); Sameep Mehta, Bangalore (IN); Muhammed Abdul Majeed Ameen, Kozhikode (IN); Abhishek Seth, Deoband (IN); Soma Shekar Naganna, Bangalore (IN)

(21) Appl. No.: 18/458,136

(22) Filed: Aug. 29, 2023

(51) Int. Cl. G06N 3/09; G06N 7/01

(52) U.S. Cl. CPC G06N 3/09; G06N 7/01

(57) ABSTRACT

A computer-implemented method for improving entity matching in a probabilistic matching engine can train a graph neural network (GNN) model on an output of a probabilistic matching engine to perform entity matching and determine counterfactual explanations for non-matches of entities. A list of data transformations can be identified by actionable recourse using the GNN model. The list of data transformations can be ranked, using the GNN model, based on computational overhead and an estimated improvement in entity matching within the probabilistic matching engine.

### BACKGROUND

The present disclosure generally relates to systems and methods using entity matching, and more particularly, to a computer-implemented method, a computer system, and a computer program product for generating and using counterfactual explanations of entity matching.

In probabilistic data matching engines, such as Match 360, data transformations are done to improve matching. Such transformations can also be used in other parts of the data fabric. Given that entity matching is a core component of a data fabric, entity matching can be leveraged for improving other downstream tasks.

Explaining why two entities did not match or what should be done to make two records match, can help identify data transformations. This way of explaining entity matching is called counterfactual explanation.

### SUMMARY

In one embodiment, a system and method are provided that can generate counterfactual explanations of entity matching, generate an ordered list of transformations, identify transformations to data from counterfactual explanations of entity matching, and identify an ordered list of transformations to be applied on the data.

In one embodiment, a computer implemented method and a computer program product can be configured to train a graph neural network (GNNs) model on an output of a probabilistic matching engine to perform entity matching. Counterfactual explanations can be determined for non-matches of entities. A list of data transformations can be identified by actionable recourse using the GNN model. In some embodiments, the list of data transformations can be ordered, according to computational overhead and improvement in entity matching, using the GNN model.

In another embodiment, a system includes a processor, a data bus coupled to the processor, a memory coupled to the data bus, and a computer-usable medium embodying computer program code, the computer program code comprising instructions executable by the processor. The instructions, executed by the processor, can train a graph neural network (GNNs) model on an output of a probabilistic matching engine to perform entity matching and determine counterfactual explanations for non-matches of entities. A list of data transformations can be identified by actionable recourse using the GNN model.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a data entry from two data sources, illustrating various data transformations made thereto to enable data entry matching, consistent with an illustrative embodiment;

FIG. 2 shows a flow chart illustrating the identification of counterfactual explanations, the identification of transformations to data, and the creation of an ordered list of transformations, consistent with an illustrative embodiment;

FIG. 3 shows a flow chart illustrating a process consistent with an illustrative embodiment; and

FIG. 4 is a functional block diagram illustration of a computer hardware platform that can be used to implement the method for the identification of counterfactual explanations, the identification of transformations to data, and the creation of an ordered list of transformations, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can generate and use counterfactual explanations of entity matching. The generated counterfactual explanations can be used to generate an ordered list of transformations, using graphical neural network (GNN) models, and to identify transformations to data using actionable recourse. The generated counterfactual explanations can further be used to identify an ordered list of transformations to be applied on the data using actionable group recourse.

According to an aspect of the present disclosure, there is provided a computer-implemented method, a system and a computer program product for improving entity matching in a probabilistic matching engine that performs several functions, including training a graph neural network (GNNs) model on an output of a probabilistic matching engine to perform entity matching and determining counterfactual explanations for non-matches of entities. The GNN model can be used to identify a list of data transformations by actionable recourse using the GNN model. The use of the GNN model can reduce computational resources, as opposed to testing the data transformations on the probabilistic matching engine.

In embodiments, which can be combined with the preceding embodiment, the list of data transformations can be ranked based on computational overhead and an estimated improvement in entity matching. The ranking of the data transformations can provide those transformations that may provide an improvement in entity matching while minimizing the computational overhead.

In embodiments, which can be combined with the preceding embodiment, the ranking of the list of data transformations is performed using the GNN model. The of the GNN model can reduce computational resources, as opposed to determining the rank of the data transformations on the probabilistic matching engine. In embodiments, which can be combined with the preceding embodiment, the computational overhead can be determined using a feature overhead (R) value, as discussed in greater detail below.

In embodiments, which can be combined with the preceding embodiment, the one or more data transformation can be deployed on the probabilistic matching engine to improve entity matching. Such deployment can result in improved data matching within the probabilistic matching engine. In embodiments, which can be combined with the preceding embodiment, an upper bound can be set on the number of data transformations in the ranked list of data transformations. Such an upper bound can limit how many data transformations may be made at a time to the probabilistic matching engine.

In embodiments, which can be combined with the preceding embodiment, user can be received to approve or reject one or more data transformations in the list of data transformations. The user feedback and the availability of data stewardship can ensure unwanted data transformations are rejected.

In embodiments, which can be combined with the preceding embodiment, rules can be generated based on the list of data transformations. These rules can be incorporated to improve matching in the probabilistic matching engine.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide a process model for the identification of counterfactual explanations, the identification of transformations to data, and the creation of an ordered list of transformations. This may have the technical effect of significantly reducing computing resources and overhead required for providing the ordered list of transformations through the use of GNN models and without testing transformations on the data within a probabilistic matching engine.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

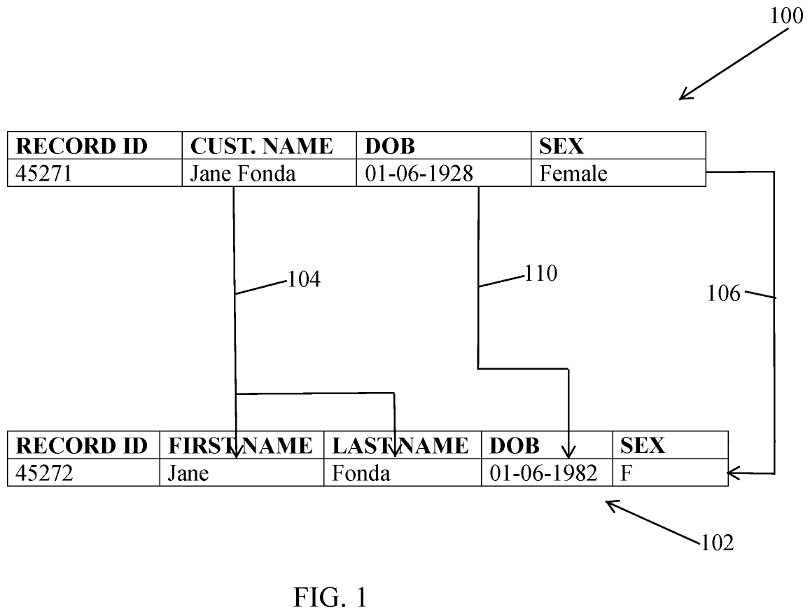

Referring to FIG. 1, a first data source 100 can include columns for record id, customer name, DOB (date of birth) and other attributes related to identifying an individual. A second data source 102 can include columns for record id, first name, last name, DOG and other attributes related to identifying an individual. Conventional probabilistic data matching engines can include standardizers that are applied on data by default. For example, the transformation identified by arrow 106 could be a standard transformation that transforms known equivalents for other attributes related to identifying an individual. Further, the transformation identified by arrow 104 could be a standard transformation where a split customer name can be equated to combined first and last names. Transformations may also be learned, as indicated by arrow 110, where such transformations may be ignored or corrected to create an entity match.

With the systems and methods of the present disclosure, should the record shown in the first data source 100 be found to not match with the record shown in the second data source 102, such a non-match can be identified and a counterfactual explanation can be provided that suggests that the last two digits of the year of birth have been transposed. Further, the system and methods of the present disclosure can identify what transformation(s) may be used to create a match in the probabilistic data matching engine and the computational overhead, as defined below, for such transformation(s). Finally, the system and methods of the present disclosure can then provide an ordered list of transformations that can optimize that matching of records in the probabilistic data matching engine.

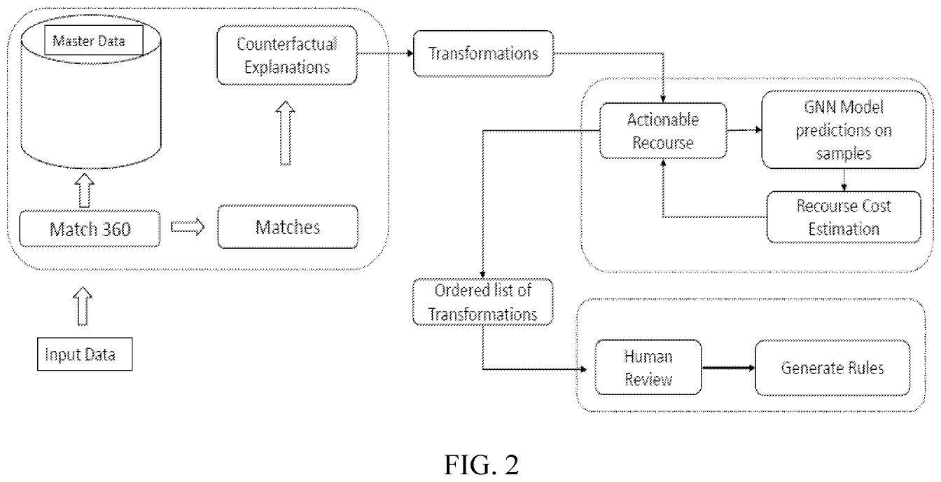

Referring to FIG. 2, a system 200 for learning counterfactual explanations on entity matching can be provided with input data 202 from one or multiple data sources. A probabilistic matching engine 204, such as Match 360, can analyze the master data 206 of the system and determine matches 208 within the data. Non-matches can be output by the graphical neural network and analyzed to determine, as a counterfactual explanation 210, why a match was not made. For example, if the name and date of birth of two data entries match in the data, but the probabilistic matching engine did not determine the two data entries as a match, the system 200 may determine that it was because certain attributes related to identifying the individual were different, such as the address was different.

The system 200 can then determine what transformations 212 may be used, via actionable recourse 214, to make the two data entries match. For example, the system 200 may determine that both the city name and the street name must be changed to create a match. GNN model predictions can be performed on the samples, to determine whether certain transformations may cause a match. This can be helpful since recourse overhead, as discussed below, in a probabilistic matching engine is prohibitively expensive. Further, the system 200 can receive human feedback before applying the transformations. Such a use of data stewardship is not available in conventional probabilistic matching engines.

In general, with actionable recourse, a recourse rule r is a tuple r=(c, c′) embedded within an if-then structure, i.e., “if c, then c′″, where c and c′ are conjunctions of predicates of the form “feature ˜ value”, where ˜∈{=, ≥, ≤} is an operator (e.g., age ≥50). A recourse set S is a set of unordered recourse rules i.e., S={(c1, c′1), (c2, c′2) . . . (cL, c′L)}. A two level recourse set R is a hierarchical model having multiple recourse sets each of which is embedded within an outer if-then structure. R={(q1, c11, c′11), (q1, c12, c′12) . . . (q2, c21, c′21) . . . } where qi corresponds to a subgroup descriptor. A two level recourse set can be used to provide a recourse to an instance x as follows: If x satisfies exactly one of the rules i in R, i.e., x satisfies qᵢ∧cᵢ, then its recourse is c′r, if x satisfies none of the rules in R, then R is unable to provide a recourse to x; or if x satisfies more than one rule in R, then its recourse is given by the rule that has the highest probability of providing a correct recourse. It should be noted that this probability can be computed directly from the data.

According to aspects of the present invention, actionable recourse 214 can be used for an entity matching task, f: X→Y, with a target outcome y*∈Y, and an instance x∈X, such that f(x)!=y* (the outcome is not met, a non-match). A counterfactual explanation is an attempt to provide a perturbation vector, a, that flips the prediction result into an entity match, i.e., f(x+a)=y*. These explanations could be individually consumed, or could be applied to similar data after user approval, or could be learned as rules. The explanations can also be used to learn data asset specific transformations (actions). To achieve this, minimize_{aEA}c(a|x), subject to f(x+a)=y*, where A is a set of feasible actions, i.e., perturbation vectors, and c is a cost function that measures the required efforts of executing an action a.

The cost 218, sometimes referred to herein as a computational overhead for actionable recourse can be determined by a feature overhead (R), which can be defined as the sum of the costs of each of the features present in c and whose value changes from c to c′, computed across all triples (q, c, c′) of R. Further, feature change (R) can be determined as the sum of magnitude of changes in feature values from c to c′, computed across all triples in R. Pairwise feature comparison inputs can be leveraged to learn the costs associated with each feature. To this end, the Bradley-Terry model can be used, which states, if p_{i,j} is the probability that feature I is less actionable (harder to change) compared to feature j, then this probability can be calculated as p_{i,j} e^{βi}/(e^{βi}+e^{βj}), where βᵢ and βⱼ correspond to the costs of features i and j, respectively. It should be noted that p_{i,j} can be computed directly from the pairwise comparisons obtained by surveying experts, as p_{i,j}=(number of i>j comparisons)/total number of i, j comparisons). The costs of the features can be retrieved by learning the maximum a posteriori probability (MAP) estimates of features βᵢ and βⱼ.

The identification of individual transformations may not be particularly useful, thus, there is a need for a list of transformations, often provided as an ordered list of transformations 220. The system 200 can further create an ordered list of transformations 220 that may optimize the matching in the probabilistic matching engine 204. The ordered list of transformations 220 may be learned vie actionable group recourse, where multiple transformation actions may be modeled to determine the transformations that can optimize matching in the probabilistic matching engine 204 while minimizing cost 218. The system 200 permits optional human review 222 and can generate rules 224 that may then be applied to the probabilistic matching engine 204 for future input data 202. The permutations to generate the counterfactual explanations can provide a predetermined upper bound on the number of transformations to apply to the data. The computation of the recourse cost and the identification of the order can be first tried on a GNN model, rather than in the probabilistic matching engine, thus saving the computational costs in testing various ordered lists of transformations.

Counterfactual explanations for multiple instances can be determined as follows. Given a set of N instances, X⊆χ such that ∀x∈X: f(x)≈+1, a set of actions A(X)=U_{x∈X}A(x), and a parameter γ>0, an action a*∈A(X) is found that is an optimal solution for the following problem:

$${min}_{a ∈ A ( X )} {g}_{γ} ( a \vert X ) := {\sum }_{x ∈ X} {i}_{γ} ( a \vert x ) .$$

A counterfactual explanation tree (CET) can be used as follows. Given a set of N instances X⊆χ such that ∀x∈X: f(x)≈+1 and parameters γ, λ>0, a CET h*∈H that is an optimal solution for the following optimization problem:

$${min}_{h ∈ ℋ} {o}_{γ , , λ} ( h \vert X ) := \frac{1}{N} {\sum }_{x ∈ X} {i}_{γ} ( h ( x ) \vert x ) + λ \cdot \vert ℒ ( h ) \vert .$$

While the first term of the learning objective o_{γ,λ}(h|X) evaluates the average invalidity i_{γ}(a|x), i.e., cost c(a|x) and loss l₀₁(f(x+a), +1), of the assigned actions a=h(x) for x∈X, the second term | [symbol] (h)| is the total number of the leaves, i.e., actions, included in h. By tuning the parameters 1, the tradeoff between the effectiveness of the actions assigned by a CET h and the interpretability of h can be adjusted. It should be noted that the framework for this CET can be applied to any classifier, f, and cost function, c, of existing counterfactual explanation methods.

### Example Process

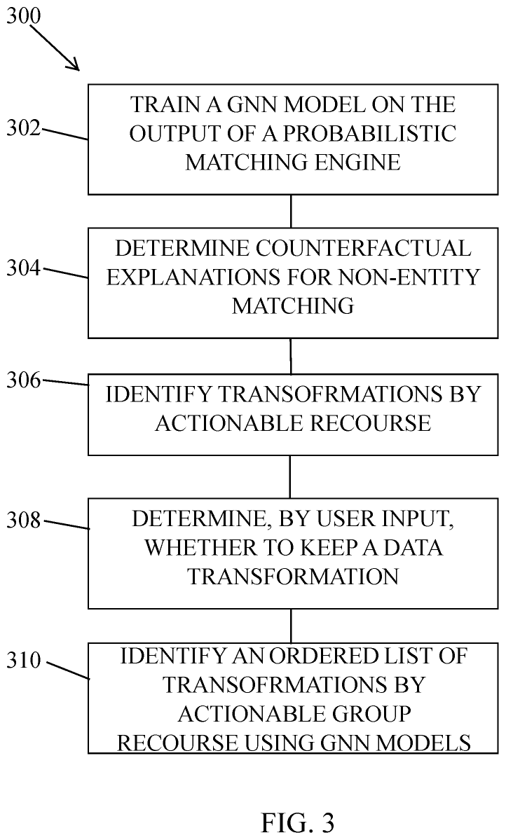

It may be helpful now to consider a high-level discussion of an example process. To that end, FIG. 3 presents an illustrative process 300 related to the method for identifying counterfactual explanations, identifying transformations to data, and creating an ordered list of transformations. Process 300 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 3, block 302 of process 300, can include an act of training a GNN model on the output of a probabilistic matching engine. The GNN can be used, as described above, to perform entity matching. While the probabilistic matching engine is optimized for scale, the trained GNN model can be optimized for quick and low computational cost inference.

At block 304, a GNN explainability technique can be used to find explanations for non-matches (counterfactual explanations). At block 306, based on the metrics of the probabilistic matching engine, data stewards (using their domain knowledge) can, optionally, decide if the data transformations should be attempted to increase matches on a data asset. At block 308, actionable recourse can be used to identify transformations. Typically, all possible data transformations can be identified, each of which is an actionable recourse, as discussed above.

While actionable recourse provides a list of transformations, at block 310, actionable group recourse can be used to identify a subset of transformations, also referred to as an ordered list of transformations, where the GNN model can be used to run different orders and different subsets of the list of transformations to rank the transformations based on computational overhead and estimated improvement in matches when deployed on the probabilistic matching engine.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

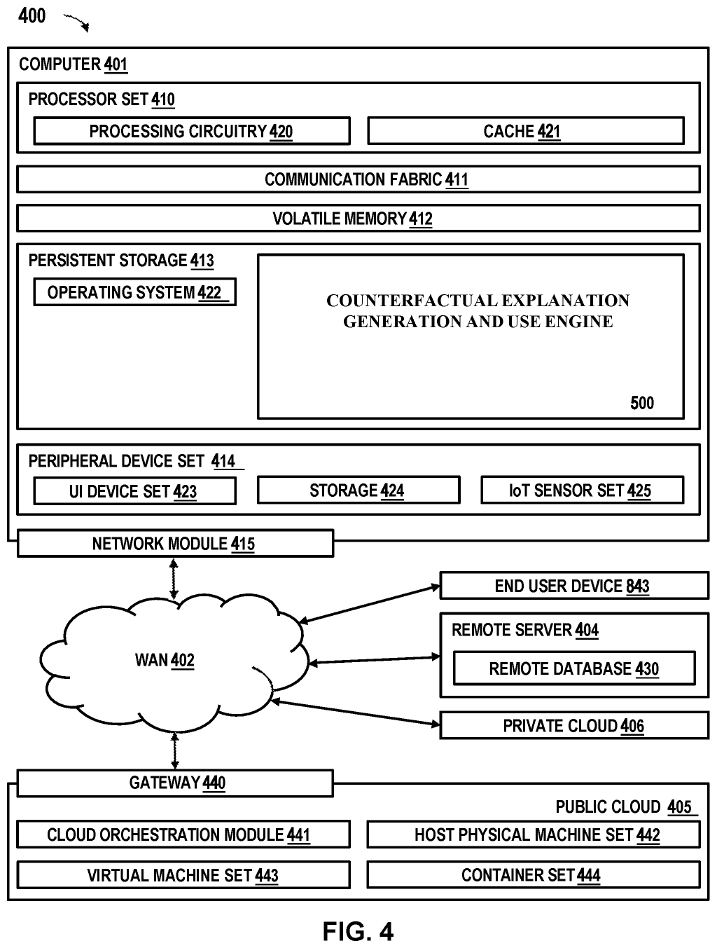

Referring to FIG. 4, computing environment 400 includes an example of an environment for the execution of at least some of the computer code involved in performing the inventive methods, including a counterfactual explanation generation and use engine block 500. In addition to block 500, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 500, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 500 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 500 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for improving entity matching, comprising:
training a graph neural network (GNNs) model on an output of a probabilistic matching engine to perform entity matching;
determining counterfactual explanations for non-matches of entities; and
identifying a list of data transformations by actionable recourse using the GNN model.

2. The computer-implemented method of claim 1, further comprising ranking the list of data transformations based on a computational overhead and an estimated improvement in entity matching.

3. The computer-implemented method of claim 2, wherein the ranking of the list of data transformations is performed using the GNN model.

4. The computer-implemented method of claim 2, further comprising determining a feature overhead (R) value to calculate the computational overhead.

5. The computer-implemented method of claim 2, further comprising deploying one or more data transformations from the ranked list of data transformations on the probabilistic matching engine to improve entity matching.

6. The computer-implemented method of claim 2, further comprising setting an upper bound on a number of data transformations in the ranked list of data transformations.

7. The computer-implemented method of claim 1, further comprising receiving user input to approve or reject one or more data transformations in the list of data transformations.

8. The computer-implemented method of claim 1, further comprising generating rules based on the list of data transformations.

9. A system comprising:
a processor;
a data bus coupled to the processor;
a memory coupled to the data bus; and
a computer-usable medium embodying a computer program code, the computer program code comprising instructions executable by the processor and configured to:
train a graph neural network (GNNs) model on an output of a probabilistic matching engine to perform entity matching;
determine counterfactual explanations for non-matches of entities; and
identify a list of data transformations by actionable recourse using the GNN model.

10. The system of claim 9, wherein the instructions are further configured to rank the list of data transformations based on computational overhead and an estimated improvement in entity matching.

11. The system of claim 10, wherein the ranking of the list of data transformations is performed using the GNN model.

12. The system of claim 10, wherein the instructions are further configured to deploy one or more data transformations from the ranked list of data transformations on the probabilistic matching engine to improve entity matching.

13. The system of claim 10, wherein the instructions are further configured to set an upper bound on a number of data transformations in the ranked list of data transformations.

14. The system of claim 9, wherein the instructions are further configured to receive user input to approve or reject one or more data transformations in the list of data transformations.

15. The system of method of claim 9, wherein the instructions are further configured to generate rules based on the list of data transformations.

16. A computer program product for improving matching in a probabilistic matching engine, the computer program product comprising a computer readable storage medium having program instructions embodied therewith, the program instructions executable by a computer to cause the computer to:
train a graph neural network (GNNs) model on an output of the probabilistic matching engine to perform entity matching;
determine counterfactual explanations for unmatched entities; and
identify a list of data transformations by actionable recourse using the GNN model.

17. The computer program product of claim 16, wherein the instructions are further configured to cause the computer to rank the list of data transformations based on computational overhead and an estimated improvement in entity matching.

18. The computer program product of claim 17, wherein the ranking of the list of data transformations is performed using the GNN model.

19. The computer program product of claim 17, wherein the instructions are further configured to cause the computer to deploy one or more data transformations from the ranked list of data transformations on the probabilistic matching engine to improve entity matching.

20. The computer program product of claim 16, wherein the instructions are further configured to cause the computer to receive user input to approve or reject one or more data transformations in the list of data transformations.
